(19) United States
(12) Patent Application Publication
(10) Pub. No.: US 2005/0046722 A1
(43) Pub. Date: Mar. 3, 2005

(54) Solid-state image capturing element and control method therefore

(75) Inventor: Yoshihiro Okada, Hashima-Shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/927,519

(22) Filed: Aug. 26, 2004

(30) Foreign Application Priority Data
Aug. 28, 2003 (JP) 2003-304174
Dec. 5, 2003 (JP) 2003-407348

(51) Int. Cl. H04N 5/335

(52) U.S. Cl. 348/311

(57) ABSTRACT

A solid-state image capturing element having a plurality of transfer electrodes arranged on the surface of a semiconductor substrate. The element stores information charge generated in response to received light incident into the semiconductor substrate, in a potential well which is formed by the action of the transfer electrode. The element has a photodiode buried in the vicinity and under the transfer electrode.

### CROSS-REFERENCE TO RELATED APPLICATIONS

The entire disclosure of Japanese Application No. 2003-304174 and 2003-407348 including specification, claims, drawings and abstract is incorporated herein by reference in its entirety.

### BACKGROUND OF THE INVENTION

1. Field of the Invention

The present invention relates to a solid-state image capturing element capable of reducing noise relative to information charges, and to a method for controlling the same.

2. Description of the Related Art

A CCD (Charge Coupled Device) solid-state image capturing element is a charge transfer element capable of orderly transferring information charges in the form of a signal packet in a single direction at a speed in synchronism with an externally supplied clock pulse.

As shown in FIG. 14, a frame transfer-type CCD solid-state image capturing element comprises an image capturing section 2i, a storage section 2s, a horizontal transfer section 2h, and an output section 2d. The image capturing section 2i is configured having a vertical shift register comprising a plurality of shift registers which extent in parallel to each other in a vertical direction (in the up-down direction in FIG. 14) and each bit of each shift register is arranged in a second dimensional array.

The storage section 2s is configured having a vertical shift register comprising a plurality of shift registers which extend, parallel to each other, in a vertical direction (along the up-down direction in FIG. 14). The vertical shift registers of the storage section 2s are light shielded, and each bit thereof functions as a storage pixel for storing information charge.

The horizontal transfer section 2h is configured having a horizontal shift register which extends in a horizontal direction (along the right-left direction in FIG. 14), and each bit thereof receives an output from each shift register of the storage section 2s.

The output section 2d is configured having a capacitance for temporally storing electric charge which has been transferred from the horizontal shift register of the horizontal transfer section 2h, and a rest transistor for discharging the charge stored in the capacitance.

Light is introduced into, and captured by, the image capturing section 2i and given photoelectric conversion in each bit of the image capturing section 2i, whereby information an charge is generated. The generated information charge arranged in a second dimensional array is transferred from the image capturing section 2i to the storage section 2s at a high speed by the vertical shift register of the image capturing section 2i, so that information charges for one frame are held in the vertical shift register of the storage section 2s.

Thereafter, information charges for each line are sequentially transferred from the storage section 2s to the horizontal transfer section 2h, and, further, information charges for each pixel are transferred from the horizontal transfer section 2h to the output section 2d. The output section 2d converts the amount of charge for each pixel into a voltage value, and the variation of the voltage value is output as a CCD output.

The image capturing section 2i and the storage section 2s each comprise a plurality of shift registers formed in a surface portion of the semiconductor substrate 10, as shown in FIGS. 15A to 15C. It should be noted that the term “a surface portion” used throughout this specification refers to an upper portion having some depth, of a layer or substrate. FIG. 15A is a plan view schematically showing a part of a conventional image capturing section 2i. FIGS. 15B and 15C are sectional side elevation views of the same along the line A-A and B-B, respectively.

Referring to FIG. 15B, a P-well (PW) 11 is formed in an N-type semiconductor substrate 9, and an N-well 12 is formed on the P-well (PW) 11. That is, a P-well 11, where P-type impurities are doped, is formed in the N-type semiconductor substrate 9, and an N-well 12, where N-type impurities are doped at a high density, is formed in the surface portion of the P-well 11.

A separating region 14 is formed for separating channel regions of the vertical shift register. Specifically, P-type impurity ions are doped into the N-well 12 in areas in parallel to, and apart by a predetermined interval from, each other. The resultant P-type impurity-doped region constitutes a separating region 14.

The N-well 12 is electrically defined by adjacent separating regions 14 such that a portion of the N-well 22, sandwiched by the separating regions 14 constitutes a channel region 22, that is, a path along which information charge is transferred. The separating region 14 provides a potential barrier between, and thus electrically separates, adjacent channel regions 22.

An insulating film 13 is formed on the surface of the semiconductor substrate 9, and a plurality of transfer electrodes 24, which are made using a poly-silicon film, are formed on the insulating film 13. The transfer electrodes 24 are deposited in parallel to each other so as to extend perpendicular to the extending channel regions 22.

Further, for reduction of the resistance component of the transfer electrode 24, backing wires 15 are formed so as to extend in parallel to the extending channel regions 22. The backing wire 15 is made using a tungsten silicide film and connected to the transfer electrode 24 via an opening formed throughout an insulating film for every predetermined number of transfer electrodes 24. A group of three adjacent transfer electrodes 24-1, 24-2, and 24-3 corresponds to a single pixel.

FIG. 16 shows potential distribution along the channel region 22 at the time of image capturing. Specifically, in image capturing, one transfer electrode in the group of transfer electrodes 24 (e.g., transfer electrode 24-2 here) is set in an ON state, while the other transfer electrodes (e.g., transfer electrodes 24-1 and 24-3 here) remain in an OFF state. As a result, a potential well 50 is formed in the channel region 22 below the transfer electrode 24-2 in an ON state, and, consequently, information charge is stored in the potential well 50.

In transferring the information charge, transfer clocks of three phases φ1 to φ3 are applied to every combination of, for example, three adjacent transfer electrodes 24-1, 24-2, and 24-3 to control the potential in the channel regions 22 below the respective transfer electrodes 24-1, 24-2, and 24-3, such that the information charge is transferred.

As described above, in the above-described conventional CCD solid-state image capturing element, in which some of the transfer electrodes 24 are set in an ON state during storage of an electric charge, a dark current is generated due to the effect of a defect level which is present along a boundary between the insulating film 13 and the N-well 12 located below the transfer electrode 24 in an ON state. Presence of a dark current results in noise relative to the information charge generated in the image capturing section 2i, and thus adversely affects an image captured by the CCD solid-state image capturing element. Dark current generation is significant in a CCD solid-state image capturing element at an increased temperature and in a long time exposure.

Further, photoelectric conversion occurs in the N-well 12 below the transfer electrode 24 in an ON stage even while the electric charge is being transferred, and, as a result, an information charge is generated. The generated electric charge results in a “smear” running in the vertical direction in the image then being transferred. That is, this is also contributes to deterioration of image quality.

### SUMMARY OF THE INVENTION

According to one aspect of the present invention, there is provided a solid-state image capturing element, having an image capturing section for generating information charge in response to light received from outside. The image capturing section is formed on a surface of a semiconductor substrate, has a plurality of channel regions, each having a substantially constant width, formed in a surface portion of the semiconductor substrate so as to extend in parallel to each other at a predetermined interval, the surface portion of the channel regions having one electric conductive type, and a plurality of transfer electrodes formed above a surface of the semiconductor substrate so as to extend in parallel to each other in a direction perpendicular to a direction in which the plurality of channel regions extend, and stores the information charge generated in response to light incident to the semiconductor substrate, in a potential well which is formed by a function of the transfer electrodes.

The solid-state image capturing element comprises a photodiode formed in the channel region in a manner of being buried, having a surface portion of an electric conductive type which is inverted from that of the channel regions, the photodiode further having a shorter length extending in a direction in which the transfer electrode extend, than a width of the channel region. In the solid-state image capturing element, the transfer electrode has a notch formed thereon such that an opening is located corresponding to the photodiode, and the information charge is moved between the channel region and the photodiode by means of a function of the transfer electrode.

According to another aspect of the present invention, there is provided a method for controlling a solid-state image capturing element, having an image capturing section for generating information charge in response to light received from outside. The image capturing section is formed on a surface of a semiconductor substrate, has a plurality of channel regions, each having a substantially constant width, formed in a surface portion of the semiconductor substrate so as to extend in parallel to each other at a predetermined interval, the surface portion of the channel regions having one electric conductive type, and a plurality of transfer electrodes formed above a surface of the semiconductor region so as to extend in parallel to each other in a direction perpendicular to a direction in which the plurality of channel regions extend; and stores the information charge generated in response to light incident to the semiconductor substrate, in a potential well which is formed by a function of the transfer electrodes.

The solid-state image capturing element comprises a photodiode formed in the channel region in a manner of being buried, having a surface portion of an electric conductive type which is inverted from that of the channel regions, the photodiode further having a shorter length extending in a direction in which the transfer electrode extend, than a width of the channel region, wherein the transfer electrode has a notch formed thereon such that an opening is located corresponding to the photodiode.

The method comprises moving the information charge between the channel region and the photodiode by means of a function of the transfer electrode.

### BRIEF DESCRIPTION OF THE DRAWINGS

Preferred embodiment(s) of the present invention will be described in further detail based on the following drawings, wherein:

FIG. 1 is a plan view showing an image capturing section of a solid-state image capturing element in a first embodiment of the present invention;

FIG. 2 is a sectional side elevation view showing an image capturing section of the solid-state image capturing element in the first embodiment of the present invention;

FIG. 3A and FIG. 3B are diagrams showing distribution of potential in the image capturing section of the solid-state image capturing element in the first embodiment of the present invention;

FIG. 4 is a plan view showing another example of an image capturing section of the solid-state image capturing element in the first embodiment of the present invention;

FIG. 5 is a lateral cross section view showing another example of an image capturing section of the solid-state image capturing element in the first embodiment of the present invention;

FIG. 6 is a plan view showing an image capturing section of a solid-state image capturing element in a second embodiment of the present invention;

FIG. 7 is a sectional side elevation view of the image capturing section of the solid-state image capturing element in the second embodiment of the present invention;

FIG. 8 is a timing chart for use in a method for controlling a solid-state image capturing element;

FIG. 9 is a diagram showing distribution of potential in the image capturing section of the solid-state image capturing element in the second embodiment of the present invention;

FIG. 10 is a diagram showing distribution of potential in the image capturing section of the solid-state image capturing element in the second embodiment of the present invention;

FIG. 11 is diagram showing distribution of potential in the image capturing section of the solid-state image capturing element during image capturing according to the present invention;

FIG. 12 is diagram showing distribution of potential in the image capturing section of the solid-state image capturing element during gate transferring according to the present invention;

FIG. 13 is diagram showing distribution of potential in the image capturing section of the solid-state image capturing element during transfer;

FIG. 14 is a conceptual diagram showing a structure of the solid-state image capturing element according to the present invention;

FIG. 15A is a plan view showing a structure of a conventional solid-state image capturing element;

FIG. 15B and FIG. 15C are sectional side elevation views showing a structure of a conventional solid-state image capturing element;

FIG. 16 is a diagram explaining storage of electric charge in a solid-state image capturing element;

FIG. 17 is a plan view showing another example of an image capturing element of a solid-state image capturing element; and

FIG. 18 is a plan view showing still another example of an image capturing element of a solid-state image capturing element.

### DESCRIPTION OF THE PREFERRED EMBODIMENTS

<First Embodiment>

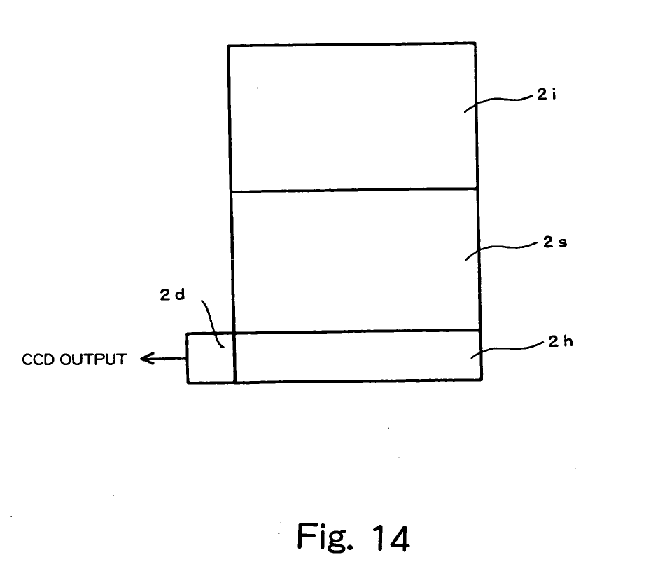

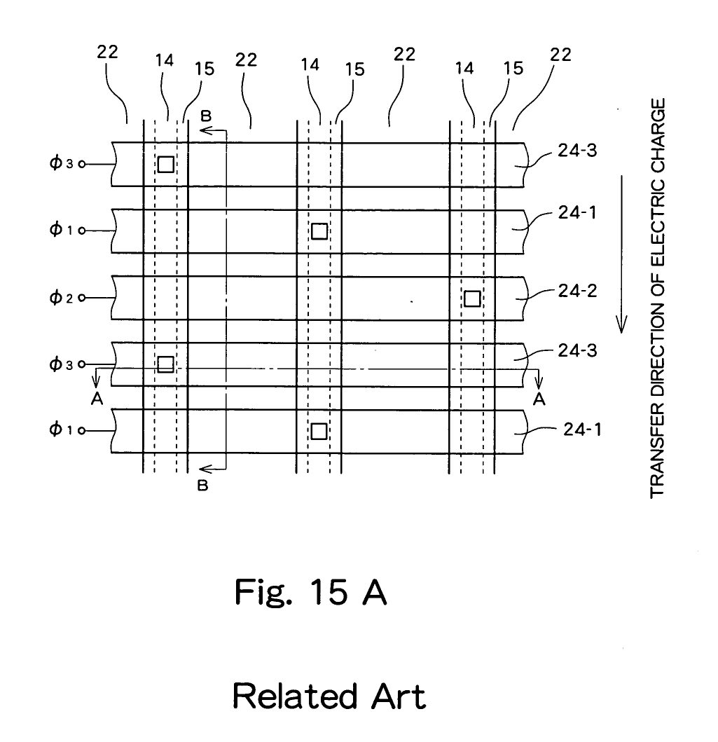

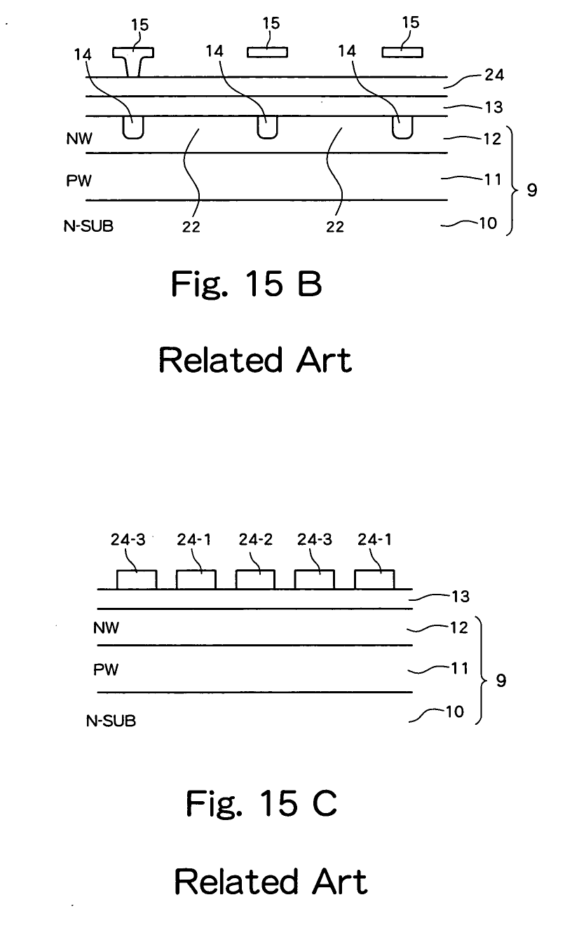

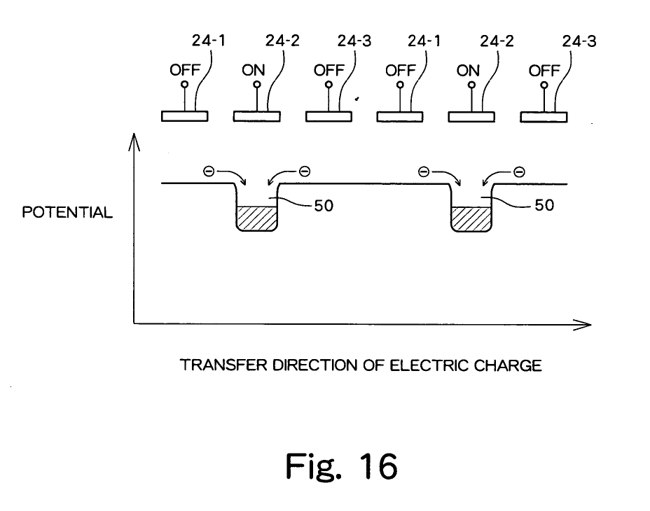

In a first embodiment of the present invention, a CCD solid-state image capturing element comprises an image capturing section 2i, a storage section 2s, a horizontal transfer section 2h, and an output section 2d, as shown in FIG. 14. It should be noted that structural components identical to those described above in connection with a conventional structure are identified using identical reference numerals, and hereafter described only briefly.

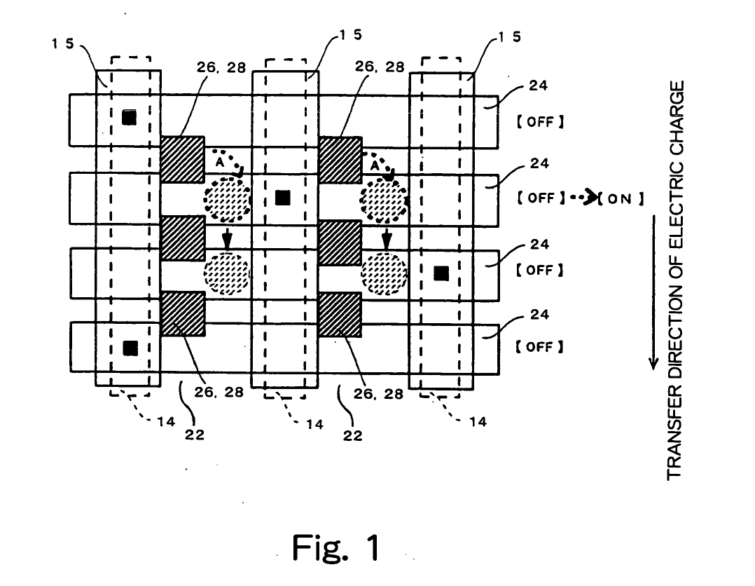

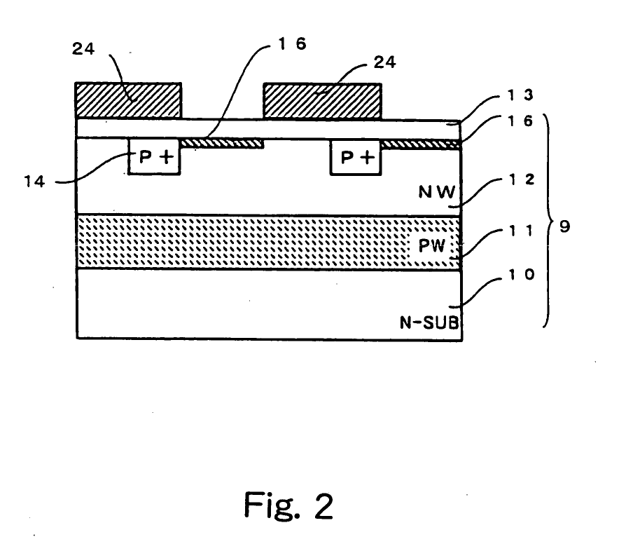

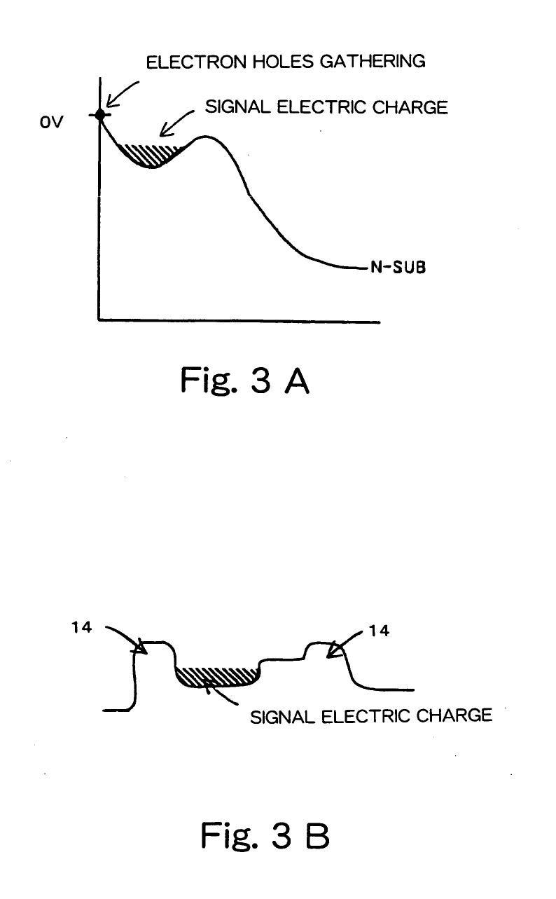

FIG. 1 is a plan view schematically showing a portion of an image capturing section 2i of a solid-state image capturing element of the present invention, and FIG. 2 is a cross sectional view of the same. FIGS. 3A and 3B are diagrams showing potential distribution in a solid-state image capturing element.

Referring to FIGS. 1 and 2, for example, a P-well 11 is formed as a p-type layer in an N-type semiconductor substrate 9 and an N-well 12 is formed thereon as an N-type layer. In addition, a gate insulating film 13 is formed over the semiconductor substrate 9, and a plurality of poly-silicon transfer electrodes 24 are formed on the gate insulating film 13.

Specifically, the N-type semiconductor substrate 9, on the surface of which an image capturing section 2i is formed, may be made using typical semiconductor material, such as a silicon substrate or the like, and doped with N-type impurities, such as arsenic (As), phosphor (P), antimony (Sb), or the like. In particular, a silicon substrate doped with impurities at a density in the range between 1×10¹⁴/cm³ and 1×10¹⁵/cm³ may preferably be used as the semiconductor substrate 9.

As P-type impurities to be doped to form the P-well 11 in the N-type semiconductor substrate 9 may include boron (B), aluminum (Al), gallium (Ga), indium (In) or the like, and the P-type impurities are preferably doped for formation of the P-well 11 at a density higher than that for the semiconductor substrate 9, more preferably, in the range between 5×10¹⁴/cm³ and 5×10¹⁶/cm³.

As N-type impurities to be doped at a high density to form the N-well (NW) 12 in a surface portion of the P-well 11 may include arsenic (As), phosphor (P), antimony (Sb), or the like, and the N-type impurities are preferably doped for formation of the N-well 12 at a density higher than that for the P-well 11, more preferably, in the range between 1×10¹⁶/cm³ and 1×10¹⁷/cm³.

The insulating film 13, which is formed over the surface of the semiconductor substrate 9, is made using insulating material, such as a silicon oxide film (SiO₂), a silicon nitride film (SiN), or the like, that is used for a semiconductor integrated device.

The plurality of transfer electrodes 24, which are formed on the insulating film 13, extend, parallel to each other, in the direction perpendicular to the direction along which channel regions 22 extend. The transfer electrodes 24 may be made using a poly-silicon film, a metal film, or combination thereof. A group of three adjacent transfer electrodes 24-1, 24-2, and 24-3 corresponds to a single pixel.

In order to electrically separate the channel regions 22 in the vertical shift register from each other, separating regions 14 are formed.

Specifically, P-type impurities are doped into the N-well 12 at a high density in areas in parallel to, and apart by a predetermined extent from, each other, so that the resultant P-type impurity-doped regions constitute the separating regions 14. The impurity doping density for the separating regions 14 is preferably in the range between 1×10¹⁶/cm³ and 5×10¹⁷/cm³.

The separating region 14 provides a potential barrier between adjacent channel regions 22, to thereby electrically separate them. The channel regions 22, each having a substantially constant width, are formed in the surface portion of the semiconductor substrate 9 so as to extend in parallel to each other in the direction perpendicular to the extending plurality of transfer electrodes 24.

It is preferable to provide a backing wire 15, which is made using a metal film, such as a tungsten silicide film, or the like, so as to extend in parallel to the extending channel regions 22. When the backing wire 15 is connected to the transfer electrode 24 through an opening formed throughout an insulating film for every predetermined number of transfer electrodes 24, resistance component of the transfer electrode 24 can be reduced.

Here, the present invention is characterized by provision of a buried-type photodiode 26. Specifically, adjacent transfer electrodes 24 are notched (28) to form an opening, as shown in FIGS. 1 and 2, and P-type impurity ions are doped into the surface portion of the semiconductor substrate 9 through the opening, so that a high density P+ type region 16 for a photodiode 26 is formed on the surface region of the semiconductor substrate 9. In the above, boron ions, for example, are doped as a p-type impurity, under doping condition of an accelerated voltage of 20 keV and a density of 1×10¹²/cm².

Alternatively, a photodiode 26 may be formed adjoining and under the transfer electrode 24, without forming a notch 28. In this case, arrangement must be made so as to allow light from the outside of the CCD solid-state image capturing element to be introduced into the photodiode 26.

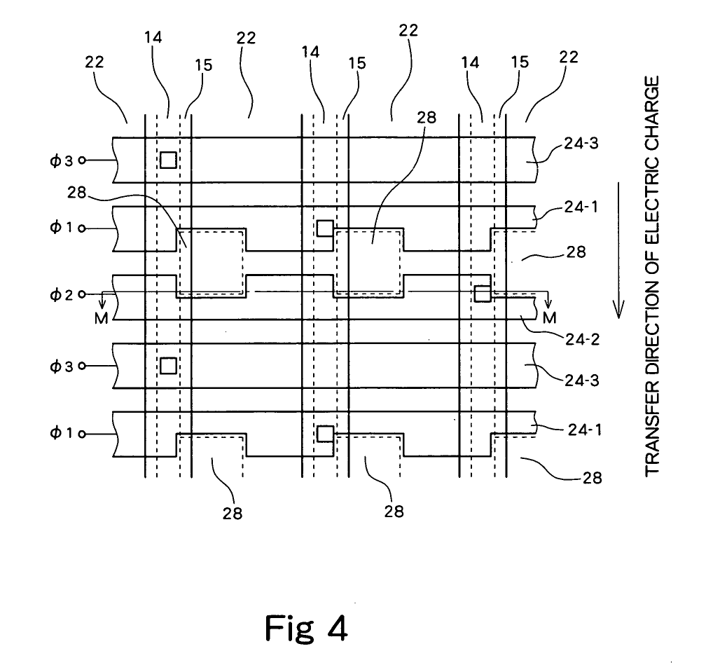

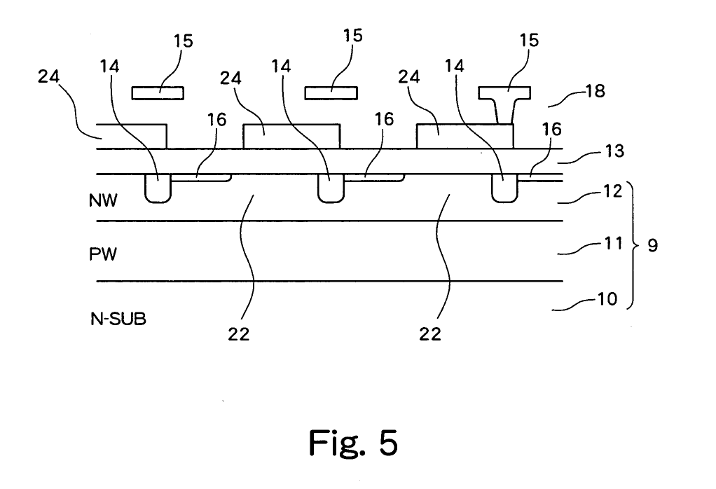

It should be noted that, while a notch 28 is formed in each transfer electrode 24, and a photodiode 26 is formed in an area corresponding to each notch 28 in FIG. 1, a notch 28 may alternatively be formed such that at least one opening is provided for every combination of a plurality of transfer electrodes 24 that define a single pixel, as shown in the plan view of FIG. 4 and the sectional side elevation view of FIG. 5 along the line M-M in FIG. 4. The shape of each notch 28 is determined so as not to split the relevant transfer electrode 24.

Thereafter, using the transfer electrode 24 as a mask, p-type impurities are doped into the surface portion of the semiconductor substrate 9 through the opening of the notch 28, to thereby form a P+ type region 16.

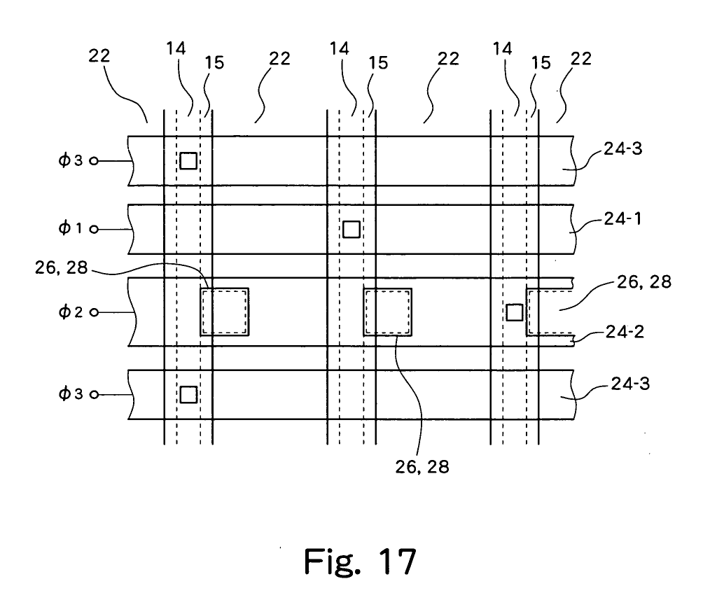

Alternatively, as shown in FIG. 17, for example, a notch 28 may be formed so as to be entirely contained in one of the plurality of transfer electrodes 24 that together define a single pixel, and a photodiode 26 may be formed in an area corresponding to that notch 28.

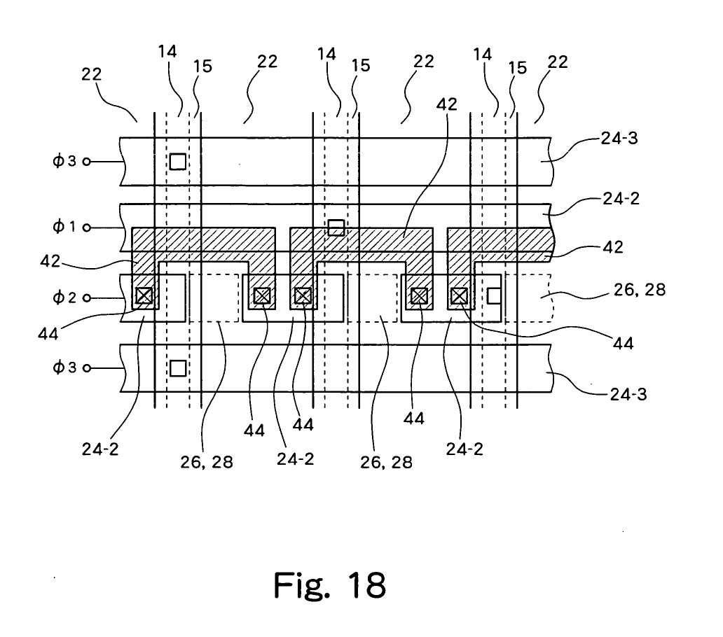

Still alternatively, as shown in FIG. 18, a transfer electrode 24 and a photodiode 26 may be alternately formed along one of the plurality of transfer electrodes 24 that together define a single pixel, and the transfer electrodes 24 may be connected to each other via an electric conductive bypass 42.

With this arrangement, the bypass 42 may be formed, utilizing a multi-layer wiring technique, on an insulating film that is formed so as to cover the transfer electrode 24, and connected to the transfer electrode 24 through an associated contact hole 44, which is formed piercing through the insulating film. In the above, the photodiode 26 preferably has a shorter length in the direction in which the transfer electrode 24 extends, than the width of the channel region 22.

It should be noted that an impurity doping density for the P+ type region 16 may preferably be adjusted to the range between 1×10¹⁶/cm³ and 5×10¹⁷/cm³.

In storing information charge in the photodiode 26, all of the transfer electrodes 24-1 to 24-3 are supplied with negative potential and thereby set in an OFF state. Thereupon, electron holes begins moving toward the interface between the insulating film 13 (SiO₂) and the N-well 12 (Si) directly below the transfer electrode 24, as shown in FIGS. 3A and 3B, and are recombined with the electric charge (a dark current) generated along the interface. As a result, dark current generation can be suppressed.

Moreover, electron holes also move toward the P⁺-type region 16 (Si) and are recombined with the electric charge (a dark current) generated along the interface between the insulating film 13 (SiO₂) and the P⁺-type region 16, so that dark current generation can be suppressed.

Consequently, the dark current generation along the interface between the insulating film 13 and the semiconductor substrate 9 can be suppressed.

Thereafter, when any one of the transfer electrodes 24 is selected and turned on, the information charge in the photodiode 26 is transferred to that selected transfer electrode 24, as indicated by the arrow A in FIG. 1. When the transfer electrode 24 in an ON state is then turned off and another transfer electrode 24 is subsequently turned on, the information charge is transferred to the transfer electrode 24 that is subsequently turned on.

This operation is repetitively performed, so that information charge can be orderly transferred in a single direction at a speed in synchronism with clock pulses φ1 to φ3.

As described above, a method for storing information charge in a buried-type photodiode 26 enables readily increase of the storage capacity, as compared to a conventional method for storing information charge in a transfer electrode.

Specifically, a conventional gate method which applies ALL Gate Pinning (AGP) driving by controlling only a voltage to be applied to a gate electrode has difficulty in increasing the amount of electric charge to store, wherein, in the AGP driving, clock pulses in raised state are supplied to all transfer electrodes 24 to have them set in an OFF state when storing information charge in the image capturing section 2i during an exposure period. However, the photodiode method can advantageously reduce such a problem.

It should be noted an AGP driving method is described in Japanese Patent Laid-Open Publication No. 2004-179231, which is file by the inventor of the present invention.

<Second Embodiment>

A CCD solid-state image capturing element according to a second embodiment of the present invention also comprises an image capturing section 2i, a storage section 2s, a horizontal transfer section 2h, and a output section 2d, as shown in FIG. 14. In this embodiment, the image capturing section 2i is mainly described in the following as it has a distinguished feature from that of a conventional image capturing section and the image capturing section 2i in the first embodiment.

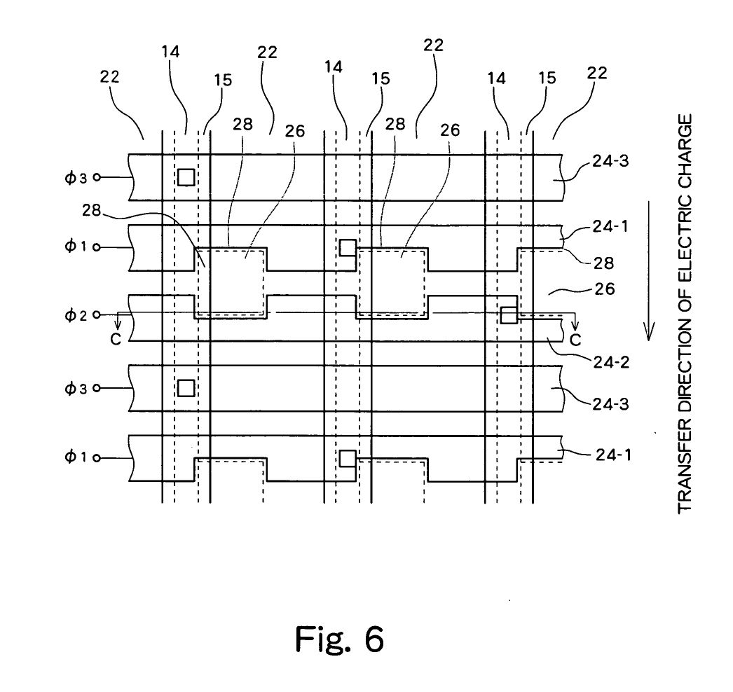

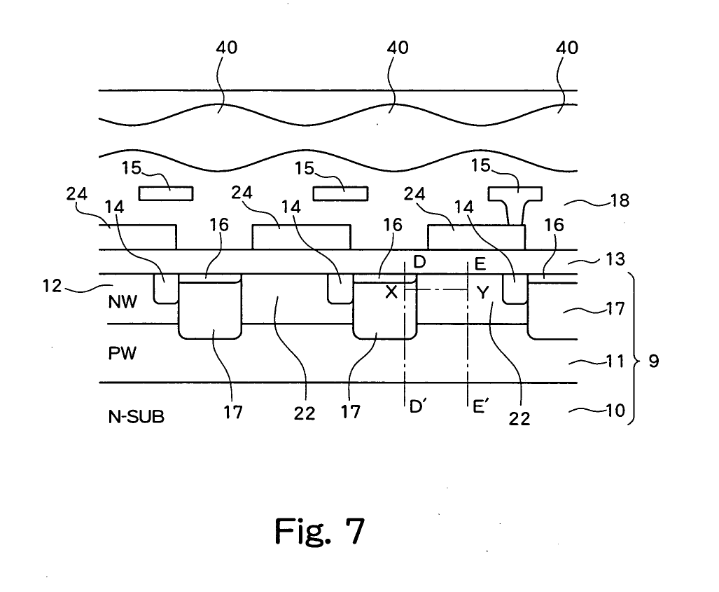

FIG. 6 is a plan view schematically showing a part of the image capturing section 2i of the solid-state image capturing element of the present invention. FIG. 7 is a sectional side elevation view of the same along the line C-C in FIG. 6. It should be noted that structural components identical to those described above are identified by the identical reference numerals, and hereafter described only briefly.

Similar as in the first embodiment, the image capturing section 2i in the second embodiment also comprises a plurality of shift registers formed in the surface portion of the semiconductor substrate 9, as shown in FIGS. 6 and 7.

Specifically, the N-type semiconductor substrate 9, on the surface of which the image capturing section 2i is formed, may be made using typical semiconductor material, such as a silicon substrate or the like, which is doped with n-type impurities, such as arsenic (As), phosphor (P), antimony (Sb), or the like. In particular, a silicon substrate doped with impurities at a density in the range between 1×10¹⁴/cm³ and 1×10¹⁵/cm³ may preferably be used as the semiconductor substrate 9.

P-type impurities are doped into the N-type semiconductor substrate 9 to form a P-well (PW) 11. The impurity doping density of the P-well 11 is preferably higher than that of the N-type semiconductor substrate 9, preferably in the range between 5×10¹⁴/cm³ and 5×10¹/cm³.

Further, N-type impurities are doped at a high density into the surface portion of the P-well 11 to thereby form an N-well (NW) 12. The impurity doping density of the N-well 12 is preferably higher than that of the P-well 11, preferably in the range between 1×10¹⁶/cm³ and 1×10¹⁷/cm³.

Still further, P-type impurities are doped at a high density into the N-well 12 in areas in parallel to, and apart by a predetermined extent from, each other, and the resultant P-type impurity-doped areas constitute separating regions 14. The impurity doping density for the separating regions 14 is preferably in the range between 1×10¹⁶/cm³ and 5×10¹⁷/cm³.

The separating regions 14 provide potential barriers in the N-well 12, which electrically separate adjacent channel regions 22. The channel regions 22, each having a substantially constant width, are formed in the surface portion of the semiconductor substrate 9 so as to extend in parallel to each other in the direction perpendicular to the direction in which the plurality of transfer electrodes 24 extend.

An insulating film 13 is formed over the surface of the semiconductor substrate 9, and a plurality of transfer electrodes 24 are formed on the insulating film 13. The transfer electrodes 24 extend in parallel to each other in the direction perpendicular to the extending separating regions 14. A group of three adjacent transfer electrodes 24-1, 24-2, and 24-3 corresponds to a single pixel.

Here, in a portion of the N-well 12, sandwiched by adjacent separating regions 14, a p⁺-type region 16 where P-type impurities are doped at a high density and an N⁺-type region 17 are formed, and the PN joint between the P⁺-type region 16 and the N⁺-type region 17 constitutes a photodiode 26. At least one photodiode 26 is provided to a group of three transfer electrodes 24-1, 24-2, and 24-3, which corresponds to a single pixel.

In formation of a transfer electrode 24 over the insulating film 13, the transfer electrode 24 is patterned by means of photolithography or the like to form a notch 28, as shown in FIG. 6. A transfer electrode 24 having a notch 28 formed thereon can be used as a mask in subsequent formation processing.

A notch 28 is formed such that at least one opening is provided for every combination of a plurality of transfer electrodes 24 that define a single pixel. The shape of a notch 28 is determined so as not to split the relevant transfer electrode 24 in the midst thereof. Further, the photodiode 26 preferably has a shorter length in the direction in which the transfer electrode 24 extends, than the width of the channel region 22.

Initially, N-type impurity ions are doped into the semiconductor substrate 9 using, as a mask, the adjacent transfer electrodes 24 having an opening defined by the notch 28 formed therein, such that the impurity ions dive deep enough to penetrate the P-well 12 and reach the N-well 11, whereby an N⁺-type region 17 is formed. The impurity doping density for the N⁺-type region 17 is preferably higher than that for the N-well 12, preferably, in the range between 1×10¹⁶/cm³ and 5×10¹⁷/cm³.

Subsequently, P-type impurity ions are doped into the surface portion of the N⁺-type region 17 at a high density to thereby form a P⁺-type region 16 at a high density. The impurity doping density for the P⁺-type region 16 is preferably higher than that for the N⁺-type region 17, preferably in the range between 1×10¹⁶/cm³ and 5×10¹⁷/cm³.

Alternatively, a photodiode 26 may be formed adjoining and under the transfer electrode 24, without forming a notch 28. In this case, arrangement must be made so as to allow light from the outside of the CCD solid-state image capturing element to be introduced into the photodiode 26.

The P⁺-type region 16 for a photodiode 26 is preferably formed in contact with the separating region 14, as shown in FIG. 7, so that the separating region 14 and the P⁺-type region 16 can always be maintained at the same potential level. In other words, as the separating region 14 is maintained at a constant potential level by controlling from the outside, independent of the transfer electrode 24, contact with the separating region 14 can always ensure a constant potential level also with the P⁺-type region 16.

In this fashion, it is possible to control such that different potential distributions are created in the photodiode 26 and the channel region 22.

It should be noted that the P⁺-type region 16 for the photodiode 26 is preferably formed less deep from the surface of the semiconductor substrate 9 than the separating region 14, so that light from the outside of the CCD solid-state image and incident into the photodiode 26 can be given photoelectric conversion at higher conversion efficiency.

Consequently, arrangement of the P⁺-type region 16 and the N⁺-type region 17 as described above enables formation of a photodiode 26 in an area corresponding to the notch 28 of the transfer electrode 24.

The image capturing section 2i captures light from the outside of the CCD solid-state image capturing element and generates information charge through photoelectric conversion, and the photodiode 26 stores the information charge generated for every pixel.

A portion of the separating region 14, which is free from a photodiode 26, constitutes a channel region 22, along which information charge is transferred. The channel regions 22 are electrically separated from each other by the separating regions 14.

In this embodiment, a transparent intermediate layer 18 is formed on the insulating film 13 and the transfer electrode 24, and an inner lens 40 is formed via the transparent intermediate layer 18. The inner lens 40 introduces light from the outside of the CCD solid-state image capturing element into an area where the photodiode 26 is formed, by bending the light from the outside of the CCD solid-stage image capturing element so as to be converged into the area of the photodiode 26. This arrangement helps achieve effective generation of information charges, as well as effective blocking of the outside light from entering any area other than the area where the photodiode 26 is formed.

It should be noted that the inner lens 40 may be substituted by any item which can prevent outside light from entering an area other than where the photodiode 26 is formed. For example, a light shielding mask having an identical opening in shape and size to the notch 28 of the transfer electrode 24 may be formed on the surface of the CCD solid-state image capturing element to produce the same advantage as that of this embodiment, though a higher light conversion rate can be attained using the inner lens 40.

In the following, a method for controlling the CCD solid-state image capturing element in this embodiment will be described.

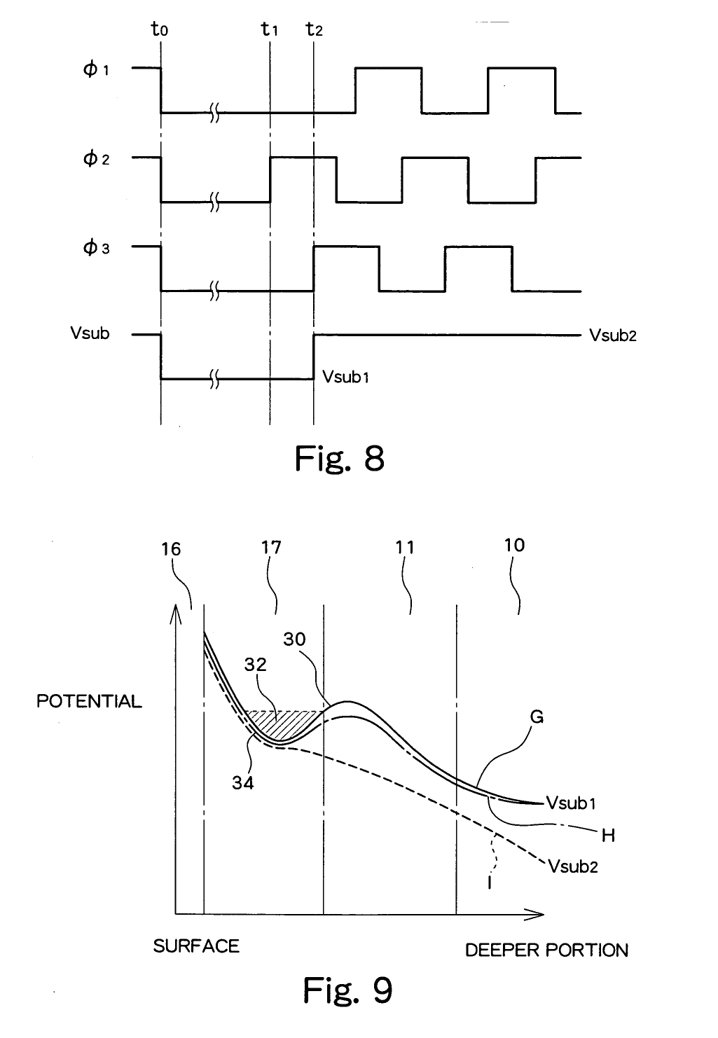

In particular, control of a CCD solid-state image capturing element in image capturing and transferring is described below with reference to the timing chart for image capturing, gate transferring, and transferring, shown in FIG. 8 as control at times other than image capturing and charge transferring to the storage section 2s is identical to that of a conventional device.

Referring to FIG. 8, clock pulses φ₁ to φ₃ are applied to the transfer electrode 24-1 to 24-3, and a substrate potential Vsub is applied to an N-type substrate (N-SUB) 10.

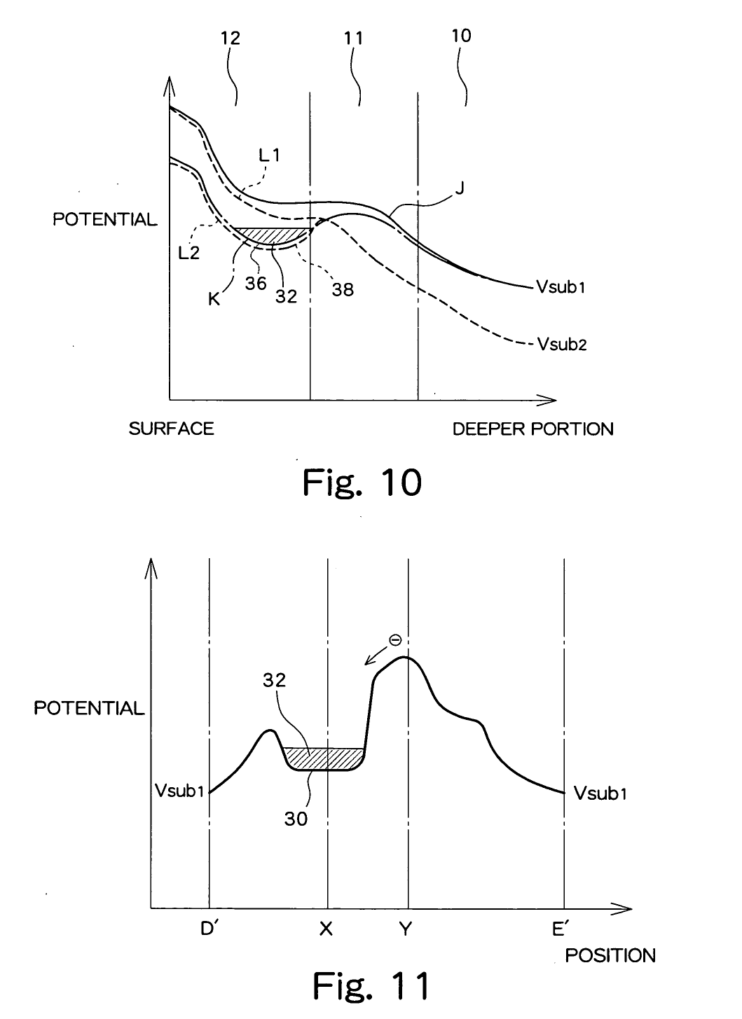

FIGS. 9 and 10 show potential distribution in the depth direction along the lines D-D′ and E-E′ in FIG. 7, respectively, at the time of image capturing and gate transferring and transferring. The abscissa of the graphs corresponds to the depth from the surface of the semiconductor substrate 9, while the ordinate thereof corresponds to potential at respective positions, with positive to negative potential shown in the up and down directions, respectively.

From time t₀ to t₁, the image capturing section 2i receives outside light to thereby capture an image. As the transfer electrodes 24-1 to 24-3, as well as the N-type substrate 10, are all fed with negative potential in image capturing, a potential distribution as indicated by line G in FIG. 9 results along the line D-D′.

That is, the potential gradually decreases going from the P⁺-type region 16 to the N⁺-type region 17, where the potential assumes its minimum value; increases going towards the P-well 11, where the potential is greatest; and thereafter again decreases going towards the N-type substrate 10. Consequently, a potential well 30 is formed in the N⁺-type region 17.

Meanwhile, potential distribution along the line E-E′ resutls, as indicated by line J in FIG. 10. That is, the potential decreases as it goes from the N-well 12 to deeper portion of the N-type substrate 10. Consequently, no potential well, or only a shallow potential well, if any, is formed along the line E-E′.

FIG. 11 shows potential distribution along the line D′-X-Y-E′ in FIG. 7 at the time of image capturing. The abscissa of the graph corresponds to positions along the line D′-X-Y-E′, while the ordinate corresponds to potential.

As indicated by the line G in FIG. 9 and the line J in FIG. 10, a potential well 30 is formed in the N⁺-type region 17 at the time of image capturing, and electric charge generated in response to the light irradiating an area around the photodiode 26 is stored as information charge 32 in the potential well 30.

When the inner lens 40 and/or a light shielding mask are provided to prevent outside light from entering any areas other than the area with the photodiode 26, no electric charge is generated in any area other than the area where the photodiode 26 is formed. In other words, information charge is generated only in the area of the photodiode 26, so that adverse smear effects can be suppressed to a still greater degree.

Referring again to FIG. 8, during times t₁ to t₂, an information charge 32 stored in the area of the photodiode 26 is gate-transferred to the channel region 22.

Specifically, either one of the transfer electrodes 24-1 and 24-2 having a notch formed thereon is fed with a positive potential, while the N-type substrate 10 is maintained at a negative potential.

In FIG. 8, the transfer electrode 24-2 is fed with a clock pulse φ₂ of positive potential. A potential distribution along the line D-D′ associated with the transfer electrode 24-2 then results, as indicated by line H in FIG. 9.

That is, the potential gradually decreases from the P⁺-type region 16 to the N⁺-type region 17, where the potential has its minimum value; the potential then increases going towards the P-well 11, where the potential assumes its maximum value; and the potential then decreases again going towards the N-type substrate 10. Consequently, a potential well 34 is formed in the N⁺-type region 17, similar to the time of image capturing.

Meanwhile, potential distribution along the line E-E′ associated with the transfer electrode 24-2 results, as indicated by the line K in FIG. 10.

That is, the potential gradually decreases towards the deeper portion in the N-well 12, where the potential is smallest; the potential then increases going towards the P-well 11, where it is greatest; and the potential then again decreases going towards the N-type substrate 10. Consequently, a potential well 36 deeper than the potential well 34 is formed in the N-well 12.

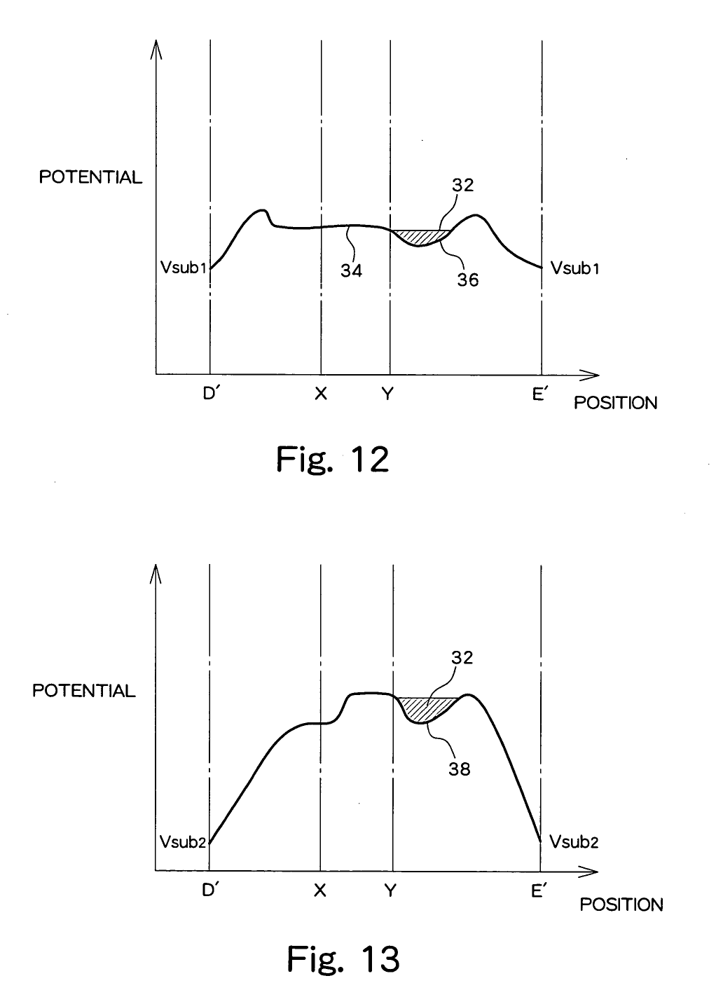

FIG. 12 shows potential distribution along the line D′-X-Y-E′ in FIG. 7 at the time of gate transferring. The abscissa of the graph corresponds to positions along the line D′-X-Y-E′, while the ordinate corresponds to potential.

As indicated by the line H in FIG. 9 and the line K in FIG. 10, the potential well 34 and the potential well 36 are formed in the N⁺-type region 17 and the N-well 12, respectively, and the potential well 34 is shallow, while the potential well 36 is deep. Therefore, the information charge 32 stored in the potential well 30, which is formed in the photodiode 26 at the time of image capturing, is transferred to the potential well 36, which is formed in the channel region 22.

Referring again to FIG. 8, at time t₂ and thereafter, the information charge 32 having been transferred to the channel region 22 is vertically transferred along the channel region 22. The transfer electrodes 24-1 to 24-3 are fed with clock pulses φ1 to φ3, which have mutually displaced phases, while the N-type substrate 10 is fed with positive potential, as shown in FIG. 8.

In the above, potential distribution along the line D-D′ results, as indicated by the line I in FIG. 9. That is, the potential gradually decreases as it goes from the P⁺-type region 16 to the N-type substrate 10. Consequently, no potential well is formed in the N⁺-type region 17.

Meanwhile, potential distribution along the line E-E′ associated with the transfer electrode 24 fed with a negative potential results, as indicated by the line L1 in FIG. 10. That is, the potential gradually decreases as it goes from the N-well 12 to the N-type substrate 10. Consequently, no potential well is formed in the N-well 12.

Potential distribution along the line E-E′ associated with the transfer electrode 24 fed with a positive potential results as indicated by the line L2 in FIG. 10. That is, the potential gradually degreases going towards the deeper portion of the N-well 12, where the potential is smallest; the potential then increases going towards the P-well 11; and the potential again decreases going towards the N-type substrate 10. Consequently, a potential well 38 is resulted in the N-well 12.

FIG. 13 shows potential distribution along the line D′-X-Y-E′ in FIG. 7 in association with the transfer electrode 24 fed with a positive potential. The abscissa of the graph corresponds to positions along the line D′-X-Y-E′, while the ordinate corresponds to potential.

As indicated by the line I in FIG. 9 and the line L2 in FIG. 10, a potential well 38 is formed in the N-well 12, and the information charge 32 is stored in this potential well 38. Thereafter, the stored information charge 32 is sequentially transferred in the direction in which the channel region 22 extends, according to variation of the clock pulses φ₁ to φ₃, which are sequentially applied to the transfer electrodes 24-1 to 24-3.

Meanwhile, no potential well is formed in the N⁺-type region 17, and the electric charge generated in the vicinity of the photodiode 26 at the time of transferring is discharged into deeper portion in the N-type substrate 10.

When one or both of the inner lens 40 or a light shielding mask are provided to prevent outside light from entering any areas other than the area where the photodiode 26 is formed, no electric charge is generated in any area other than the area with the photodiode 26, and, moreover, the electric charge generated in the area of the photodiode 26 can be discharged into deeper portion of the N-type substrate 10. Consequently, adverse effects on the information charge 32 by the electric charge which is newly generated in response to the light received at the time of transferring can be prevented. That is, instances of generation of a smear at the time of transferring can be suppressed.

As described above, a method for storing information charge in a buried-type photodiode 26 enables readily increase of the storage capacity, as compared to a conventional method for storing information charge in a transfer electrode.

Specifically, a conventional gate method which applies ALL Gate Pinning (AGP) driving by controlling solely a voltage to be applied to a gate electrode is often insufficient for increasing the amount of electric charges to store, wherein, in AGP driving, clock pulses in a raised state are supplied to all transfer electrodes 24 to set all in an OFF state when information charges are being stored in the image capturing section 2i during an exposure period. However, the photodiode method can advantageously reduce such a problem.

Further, provision, along the interface between the insulating film 13 and the semiconductor substrate 9, of an area to which electric holes move to gather during the storing of information charges, enables recombination of the gathered electric holes and the electric charge generated along the interface, such that dark current generation can be prevented.

Moreover, as an electric charge which is newly generated in response to the light received at the time of transferring can be discharged into a deeper portion of the N-type substrate 10, generation of a smear at the time of transferring can be suppressed. That is, image quality of a solid-state image capturing element can be enhanced without deteriorating either sensitivity or saturate output.

It should be noted that the present invention is not limited to the above-described embodiments and can be modified without departing from the gist of the present invention.

With use of the present invention, dark current generation can be suppressed without deteriorating either the sensitivity or saturate output. Further, noise of information charge obtained in image capturing while using a solid-state image capturing element can be reduced. Consequently, quality of an image captured using an solid-state image capturing element can be enhanced.

1. A solid-state image capturing element, having an image capturing section for generating information charge in response to outside light, in which the image capturing section is formed on a surface of a semiconductor substrate, has a plurality of channel regions, each having a substantially constant width, formed in a surface portion of the semiconductor substrate so as to extend in parallel to each other at a predetermined interval, the surface portion of the channel regions having one electric conductive type, and a plurality of transfer electrodes formed above a surface of the semiconductor substrate so as to extend in parallel to each other in a direction perpendicular to a direction in which the plurality of channel regions extend, and stores the information charge generated in response to light incident to the semiconductor substrate, in a potential well which is formed by a function of the transfer electrodes, the solid-state image capturing element; comprising:
a photodiode formed in the channel region in a manner of being buried, having a surface portion of an electric conductive type which is inverted from that of the channel regions, the photodiode further having a shorter length extending in a direction in which the transfer electrode extend, than a width of the channel region,
wherein
the transfer electrode has a notch formed thereon such that an opening is located corresponding to the photodiode, and
the information charge is moved between the channel region and the photodiode by means of a function of the transfer electrode.

2. The solid-state image capturing element according to claim 1, wherein the density of an impurity doped in a part where the photodiode is formed, the part having one electric conductive type, is higher than that of the channel region.

3. The solid-state image capturing element according to claim 1, further comprising:
a separating region formed between the plurality of channel regions, and having a surface portion of an electric conductive type which is inverted from that of the channel region,
wherein
a part where the photodiode is formed is in a vicinity of the separating region.

4. The solid-state image capturing element according to claim 1, wherein the solid-state image capturing element is formed so as to prevent outside light from entering a part other than a part where the photodiode is formed on the surface of semiconductor substrate.

5. The solid-state image capturing element according to claim 1, further comprising:
a lens for introducing outside light to solely a part where the photodiode is formed.

6. The solid-state image capturing element according to claim 1, wherein the solid-state image capturing element is formed so as to allow at least one of the separating regions and the surface portion of the photodiode to have identical potential.

7. A method for controlling a solid-state image capturing element, having an image capturing section for generating information charge in response to outside light, in which the image capturing section is formed on a surface of a semiconductor substrate, has a plurality of channel regions, each having a substantially constant width, formed in a surface portion of the semiconductor substrate so as to extend in parallel to each other at a predetermined interval, the surface portion of the channel regions having one electric conductive type, and a plurality of transfer electrodes formed above a surface of the semiconductor substrate so as to extend in parallel to each other in a direction perpendicular to a direction in which the plurality of channel regions extend, and stores the information charge generated in response to light incident to the semiconductor substrate, in a potential well which is formed by a function of the transfer electrodes, the solid-state image capturing element, comprising, a photodiode formed in the channel region in a manner of being buried, having a surface portion of an electric conductive type which is inverted from that of the channel regions, the photodiode further having a shorter length extending in a direction in which the transfer electrode extend, than a width of the channel region, wherein the transfer electrode has a notch formed thereon such that an opening is located corresponding to the photodiode, the method, comprising:
moving the information charge between the channel region and the photodiode by means of a function of the transfer electrode.

8. The method for controlling the solid-state image capturing element according to claim 7, comprising: changing potential of the semiconductor substrate.
